(19) United States
(12) Patent Application Publication
(10) Pub. No.: US 2010/0126357 A1
(43) Pub. Date: May 27, 2010

(54) REMOVABLE GRILL FOR COOKING APPARATUS

(75) Inventors: Vincenzo Misceo, North Vancouver (CA); Raffaele Misceo, Vancouver (CA); Alexander J. Feldman, Vancouver (CA); Herb Bentz, Surrey (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Vincenzo Misceo, North Vancouver, BC (CA)

(21) Appl. No.: 12/091,721

(22) PCT Filed: Oct. 30, 2006
(86) PCT No.: PCT/CA2006/001786

§ 371 Date: Sep. 30, 2009

Related U.S. Application Data
(60) Provisional application No. 60/731,473, filed on Oct. 31, 2005.

(51) Int. Cl. A47J 37/06; H05B 3/68

(52) U.S. Cl. 99/378; 219/450.1; 219/465.1

(57) ABSTRACT

A removable grill for a baking or grilling appliance is disclosed. The grill has a spring element attached to the side opposite the cooking surface which centrally engages the electric heating element and can be attached or removed by insertion and rotation of the grill.

### CROSS-REFERENCE TO RELATED APPLICATION

The present application claims priority from U.S. provisional patent application No. 60/731,473, filed Oct. 31, 2005, which is pending.

### TECHNICAL FIELD

The invention relates to cooking appliances and more particularly to cooking and baking grills having removable grill surfaces.

### BACKGROUND

Appliances for cooking food which use upper and lower opposed cooking surfaces are widely used for both home and commercial applications. For home applications, sandwich, hamburger and waffle grills are popular. Typically these will consist of a pair of heated grills or griddle plates, each having a fixed lower heated griddle plate and a pivoting heated upper griddle plate which can be manually pivoted by an attached handle into, or out of, position above the fixed griddle plate. In commercial applications, waffle cones for ice cream shops are often baked on-site using manual waffle cone griddles also called pizelle irons. Many restaurants provide pannini grills for baking pannini sandwiches in which a top cooking element is lowered onto the sandwich to cook both sides of the sandwich simultaneously. The present inventor has designed waffle cone and pannini grills in which the upper grill surface is automatically raised and lowered, as shown in U.S. Pat. Nos. 6,044,755 and 6,321,639.

The grills on such appliances require constant cleaning to remove grease and waste food material Also it may be desirable to change the grill surface to cook different food types. consequently various mechanisms have bee developed to permit removal and replacement of the grill surfaces. For example, U.S. Pat. Nos. 4,799,619 and 5,070,775 disclose two-sided cooking devices in which the cooking surface of the upper movable platen is removably secured by threaded nuts and bolts. U.S. Pat. Nos. 4,002,112; 6,429,409 and 6,820,537 disclose cooking appliances with removable grill plates wherein the grill plate is removably held in place by a latch or spring clip. Particularly for commercial applications such designs may not be sufficiently durable to tightly secure the grill after repeated replacements and repetitive uses. Also where the latch is exposed it may become caked with food and grease. It is desirable therefore to provide a design for a removable grill which is both convenient to replace and durable

### SUMMARY OF INVENTION

The invention provides a removable grill for the cooking plate assembly of an appliance for baking or grilling food items wherein the cooking plate assembly comprises a heater assembly, the removable grill having a cooking side comprising a cooking surface and a connecting side opposite to the cooking side with a raised boss extending from the connecting side, the heater assembly comprising a central aperture for receiving the raised boss of the removable grill and the removable grill comprising a spring element secured to the raised boss on the connecting side and adapted to removably engage the heater assembly when the boss is inserted into the central aperture of the heater assembly and the grill is rotated relative to the heater assembly from a first position in which the grill can be removed from the heater assembly to a second position wherein the heater assembly is secured to the grill and is positioned between the grill plate and the spring element.

### BRIEF DESCRIPTION OF DRAWINGS

In drawings which disclose a preferred embodiment of the invention:

FIG. 1 is a perspective view of a cooking appliance;

FIG. 2 is a side view thereof;

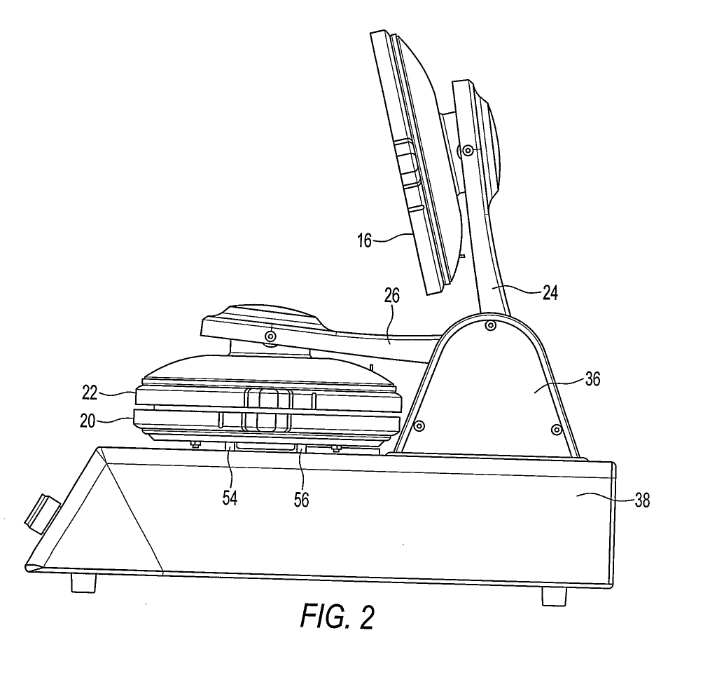

FIG. 3 is a cross-section through the grill, in perspective;

FIG. 4 is a cross-section through the grill, in perspective from above;

FIG. 5 is a top perspective view of the grill/heater module assembly in unlocked position;

FIG. 6 is a top view of the grill in locked position;

FIG. 7 is an exploded perspective view of the grill/heater module assembly from above;

FIG. 8 is an exploded perspective view of the grill/heater module assembly from below;

FIG. 9 is a top perspective view of the heater assembly;

FIG. 10 is a cross-section of the heater assembly shown in FIG. 9;

FIG. 11 is a top perspective view of the grill plate;

FIG. 12 is a top perspective view of the grill plate with leaf spring attached;

FIG. 13 is a top perspective view of the grill plate with heat transfer plate in position for attachment;

FIG. 14 is a top view of the grill in unlocked position; and

FIG. 15 is a top view of the grill in locked position.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

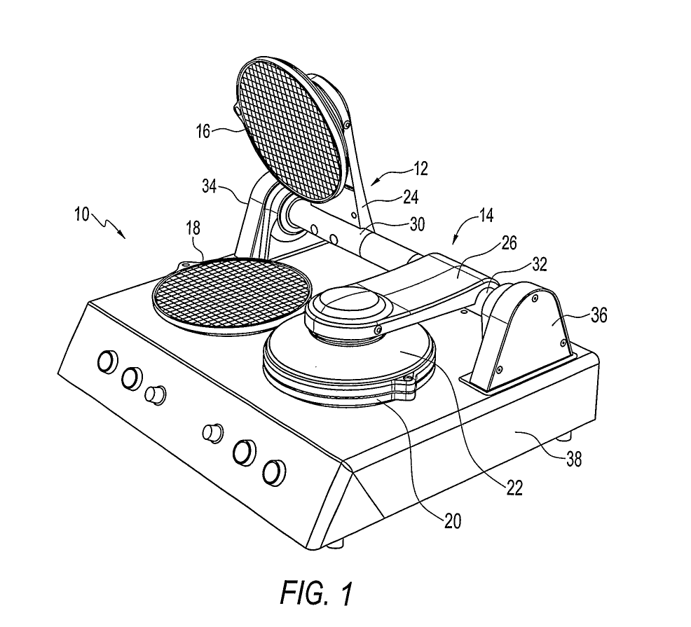

With reference to FIG. 1, a cooking appliance 10 for baking or grilling food items such as waffle cones or pannini sandwiches is shown, of the type disclosed on the present inventor's U.S. Pat. Nos. 6,044,755 and 6,321,639, which are incorporated herein by reference. It has two cooking plate assembly pairs 12,14 each having opposed cooking plate assemblies 16, 18, and 20, 22 respectively. Upper cooking plate assemblies 16, 22 pivot on arms 24, 26 into and out of position with respect to the lower cooking plate assemblies 18, 20. In the particular embodiment shown, arms 24, 26 are automatically pivoted on rotating shafts 30, 32 driven through linkages in linkage housings 34, 36 which are in turn driven by two electric motors in main housing 38.

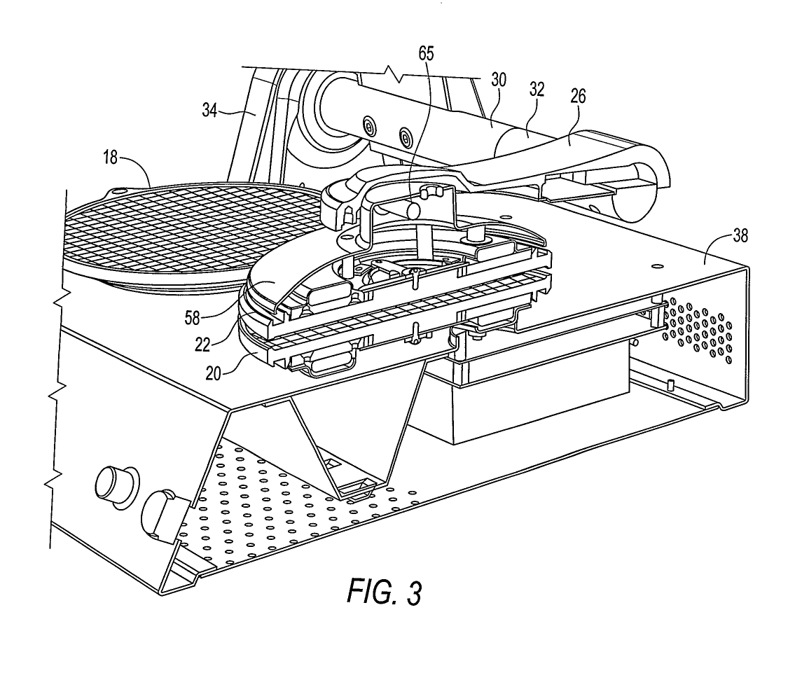

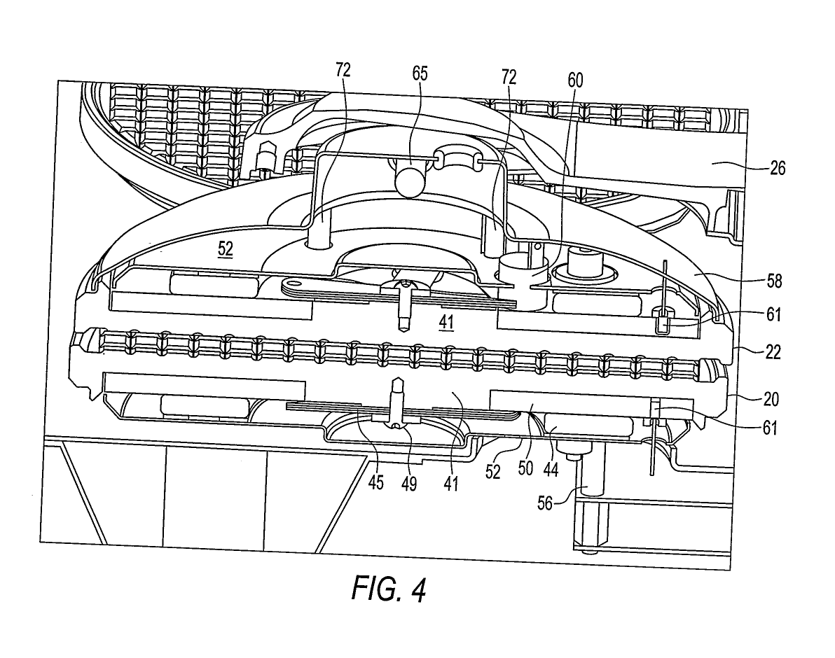

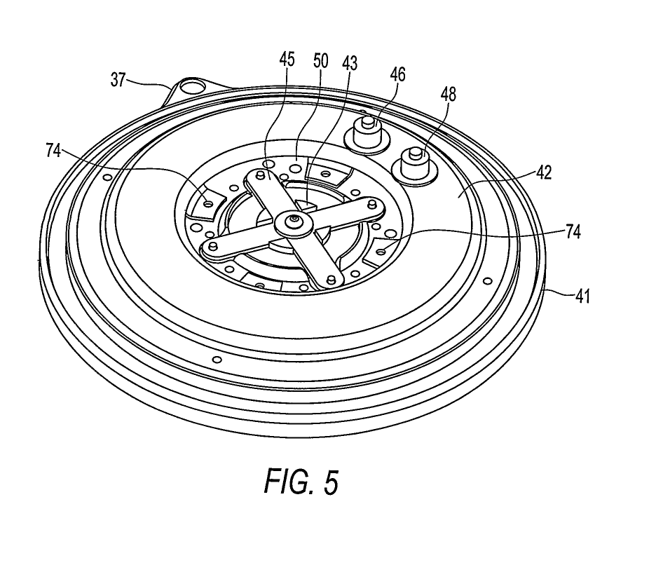

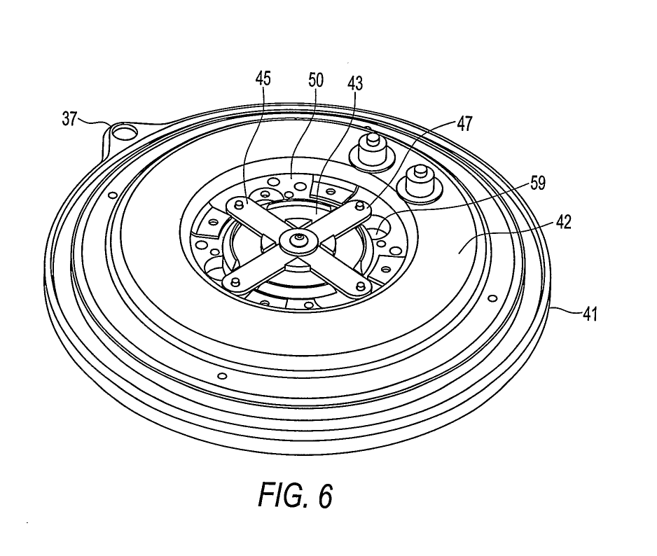

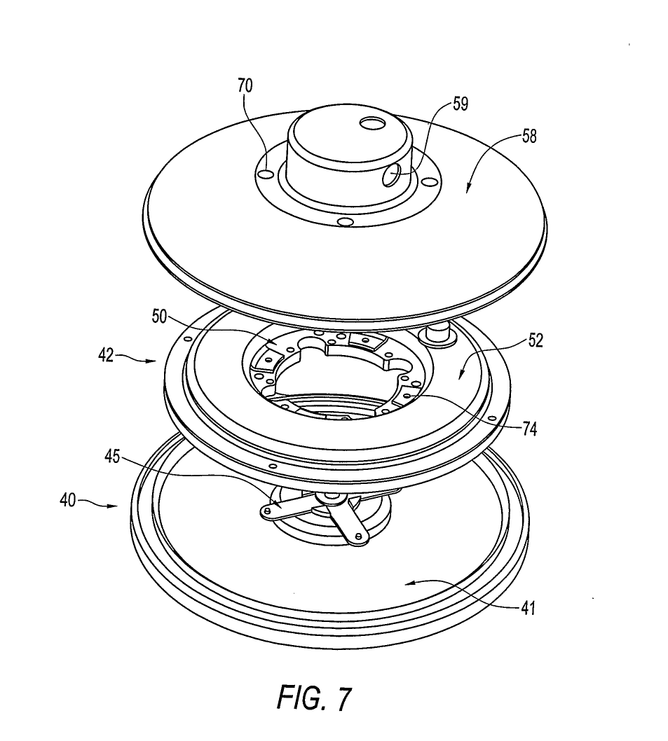

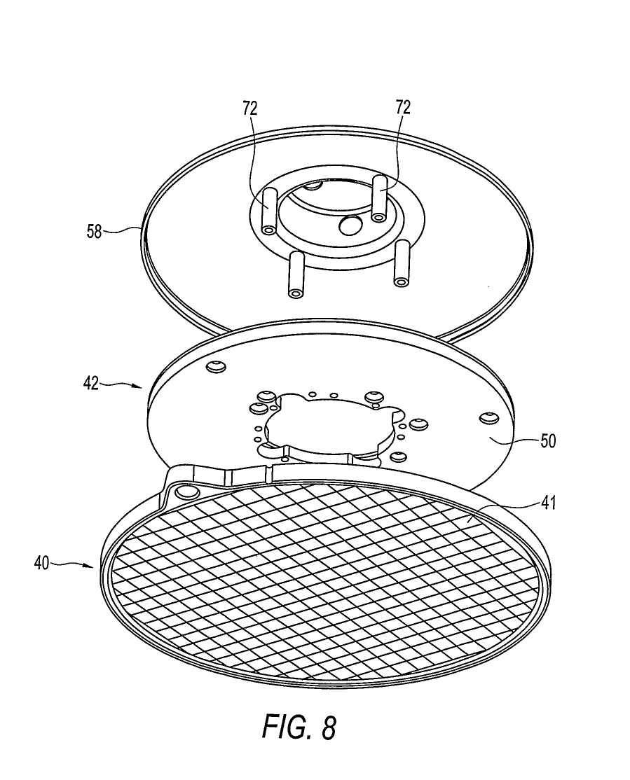

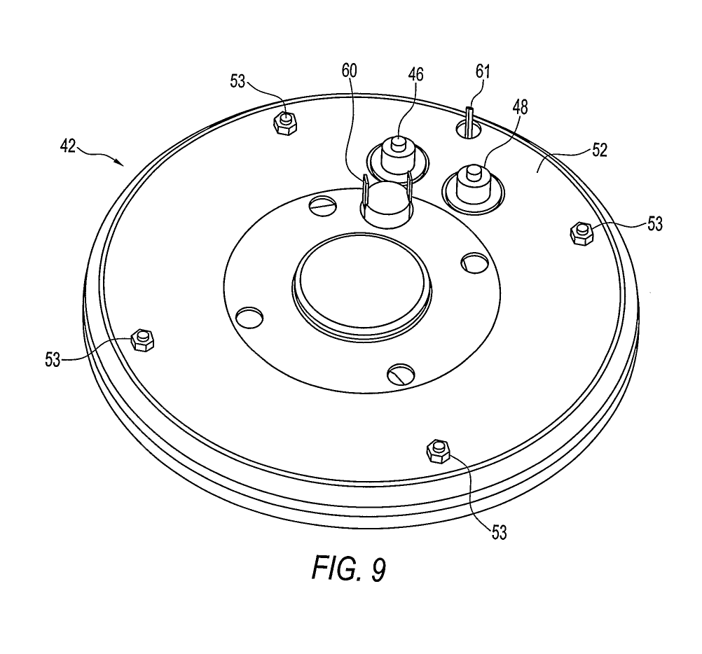

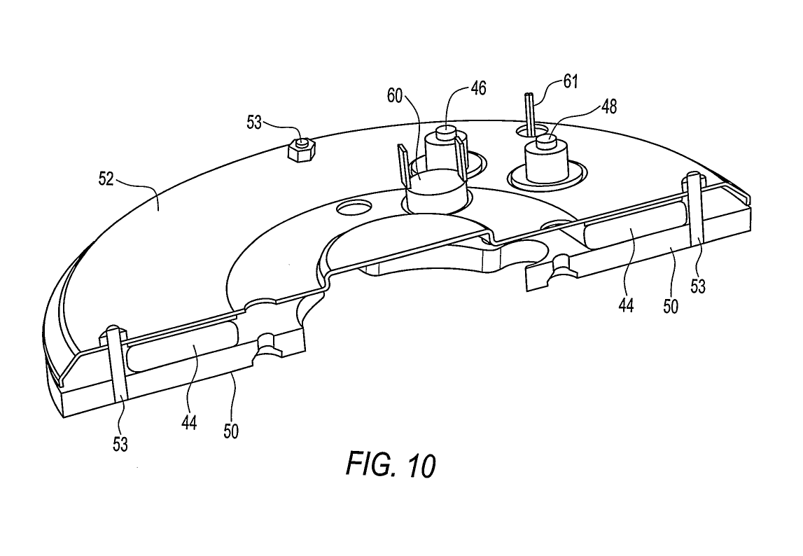

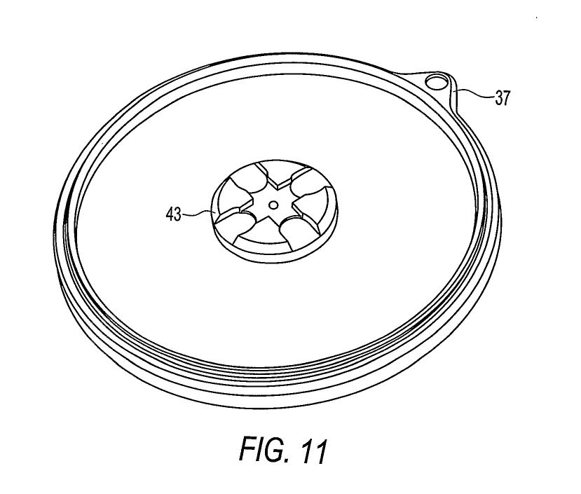

The construction of the cooking plate assemblies is shown in further detail in FIGS. 3-14. Each cooking plate assembly 16, 18, 20, 22 comprises a grill 40 and a heater assembly 42. Grill 40 comprises a cast iron grill plate 41 which has a TEFLON™ coated cooking surface 44 having the desired contour and surface pattern according to the food item to be cooked, and attached leaf spring 45. Heater assembly 42 has an electric heating element 44 connected to electrical terminals 46, 48 through which the electrical supply to heating element 44 is provided, heat transfer plate 50 and element shield 52. Electric heating element 44 is tightly sandwiched between heat transfer plate 50 and element shield 52 by bolts 53. Lower cooking plate assemblies 18, 20 are mounted on posts 54, 56 secured to housing 38. The heater assemblies 42 of upper cooking plate assemblies 16, 18 are each secured to a top cover 58 which in turn is pivotally connected on axle 65 through aperture 59 to arms 24 or 26. The heater assemblies 42 are secured to top covers 58 by bolts extending through holes 70 in spacers 72 and extending into threaded holes 74 in heat transfer plate 50. A thermocouple temperature sensor 60 extends through element shield 52 to sense the temperature of the grill plate 41.

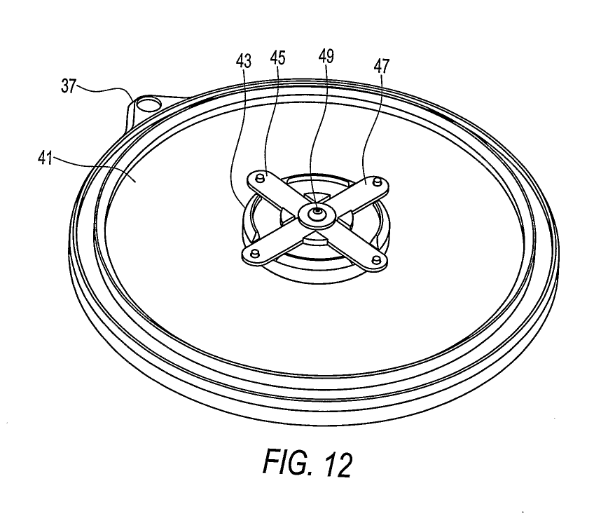

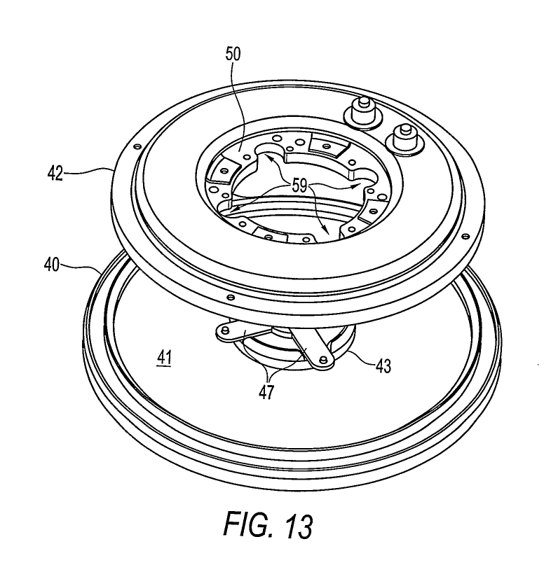

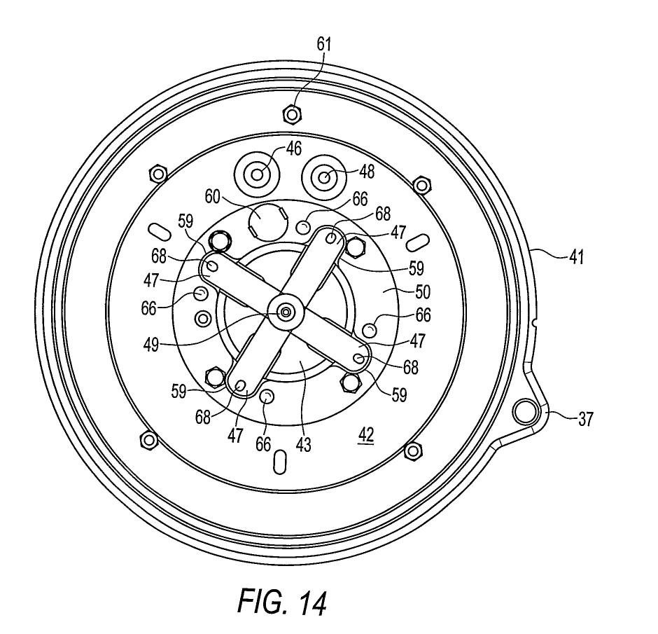

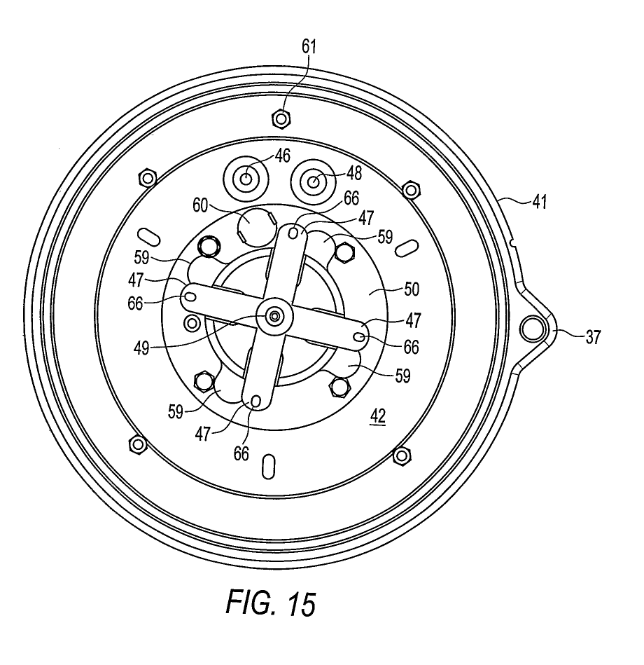

As illustrated in FIG. 12, leaf spring 45 is cruciform in shape with four arms 47, and is secured centrally to circular boss 43 of grill plate 41 by screw 49. The outer ends of arms 47 are free to flex vertically. As shown in FIG. 13, heater assembly 42 is positioned over grill 40 so that arms 47 extend through slots 59 of heat transfer plate 50 to the position shown in FIG. 14. An ear 37 on grill plate 41 can be used to orient one grill plate 41 with respect to the opposite plate 41. Grill 40 is then rotated counterclockwise about 20 degrees relative to the heater assembly 42, causing arms 47 of spring 45 to ride over and bear down on the upper surface of heat transfer plate 50 until the position shown in FIG. 15 is reached and domes 66 on the heat transfer plate pop into detents 68 in arms 47. Alternatively the domes may be in the ends of arms 47 and the detents in the surface of the heat transfer plate 50.

Grill 40 can be readily removed for cleaning by rotating the grill 40 clockwise, with reference to FIG. 15, until arms 47 are aligned with slots 59 of heat transfer plate 50, to the position shown in FIG. 14 and then separating the grill 40 from heating element 42. In this way the grills are readily removable and replaceable, yet are securely held to the appliance when installed, and the connecting mechanism is not exposed to the cooking environment and so does not become caked with food or grease.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. In an apparatus for baking or grilling food items comprising a cooking plate assembly mounted on a housing and provided with an electric heating element, the improvement wherein said cooking plate assembly comprises a heater assembly connected to said housing and a removable grill having a cooking side comprising a cooking surface and a connecting side opposite to said cooking side with a raised boss extending from said connecting side, said heater assembly comprising a central aperture for receiving said raised boss of said removable grill and said removable grill comprising a spring element secured to said connecting side on said raised boss and adapted to removably engage said heater assembly when said boss is inserted into said central aperture of said heater assembly and said grill is rotated relative to said heater assembly from a first position in which said grill can be removed from said heater assembly to a second position wherein said heater assembly is secured to said grill and is positioned between said grill plate and said spring element.

2. The apparatus of claim 1 wherein said spring element comprises a plurality of arms centrally secured to said grill and having free ends biased towards the upper surface of said grill whereby said heater element is secured between said spring and said grill when said grill is in said second position.

3. The apparatus of claim 1 wherein said spring element comprises a plurality of radially extending arms secured centrally to said grill plate whereby said arms are free to move in a direction towards and away from said grill plate at the outer ends thereof.

4. A removable grill for the cooking plate assembly of an appliance for baking or grilling food items wherein said cooking plate assembly comprises a heater assembly, said removable grill having a cooking side comprising a cooking surface and a connecting side opposite to said cooking side with a raised boss extending from said connecting side, said heater assembly comprising a central aperture for receiving said raised boss of said removable grill and said removable grill comprising a spring element secured to said raised boss on said connecting side and adapted to removably engage said heater assembly when said boss is inserted into said central aperture of said heater assembly and said grill is rotated relative to said heater assembly from a first position in which said grill can be removed from said heater assembly to a second position wherein said heater assembly is secured to said grill and is positioned between said grill plate and said spring element.

5. The removable grill of claim 4 wherein said spring element comprises a plurality of arms centrally secured to said grill and having free ends biased towards the upper surface of said grill whereby said heater element is secured between said spring and said grill when said grill is in said second position.

6. The removable grill of claim 4 wherein said spring element comprises a plurality of radially extending arms secured centrally to said grill plate whereby said arms are free to move in a direction towards and away from said grill plate at the outer ends thereof.
